(19) United States
(12) Patent Application Publication
(10) Pub. No.: US 2008/0273673 A1
(43) Pub. Date: Nov. 6, 2008

(54) HANDLING OF TELEPHONE CALLS

(75) Inventors: Magnus OTTOSSON, Kavlinge (SE); Mats ORMIN, Malmo (SE); Hanshenric CARENBORN, Lund (SE); Russel HUGHES, Alton Hampshire (GB); Robin PETERSSON, Lund (SE)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(73) Assignee: SONY ERICSSON MOBILE COMMUNICATIONS AB, Lund (SE)

(21) Appl. No.: 11/742,660

(22) Filed: May 1, 2007

(51) Int. Cl. H04M 1/64

(52) U.S. Cl. 379/88.02; 379/88.01; 379/88.21; 455/414.1

(57) ABSTRACT

A method of handling an incoming call from a first communication device addressed to a second communication device, the first and second communication devices being operative in a communication network, wherein the second communication device or the communication network comprises an answering unit. The answering unit includes a privacy data unit comprising a privacy code message for bypassing the answering unit. The method comprises receiving, by means of the answering unit, the incoming call intended for and addressed to the second communication device. Furthermore, the method comprises determining whether also a code message is received by the answering unit. If so, the method comprises comparing the received code message with the privacy code message stored in the privacy data unit to determine whether the incoming call should bypass the answering unit and, thereby, be directly forwarded to the second communication device being addressed by the first communication device in the incoming call. Thereby, a user of the second communication device may be permitted to intercept the incoming call from the calling first communication device.

### TECHNICAL FIELD

The present invention relates generally to the field of telecommunications. More specifically, the invention relates to answering machine functionality and, in particular, methods and answering units for improving the handling of an incoming telephone call from one communication device intended for and addressed to another communication device.

### BACKGROUND

Various types of handheld devices having communication capabilities, which may communicate with each other via a communication network, are known in the prior art, such as portable mobile radio communication equipment, mobile radio terminals, mobile telephones, pagers, communicators, electronic organizers, and smartphones. The communication network may e.g. be a mobile communication network, such as a GSM (Global System for Mobile communication) network, or a WCDMA (Wideband Code Division Multiple Access) network as specified e.g. by 3GPP (3^{rd} Generation Partnership Project).

A handheld communication device may receive telephone calls, which are considered by the recipient as being unsolicited. This may, under certain circumstances, become troublesome for the users of such handheld communication device. For example, when the user of the handheld communication device is at a meeting, the user normally does not want to be unnecessarily disturbed by incoming telephone calls. Likewise, when the user of the handheld communication device is on a vacation, the user also does not normally want to be disturbed by incoming telephone calls. Furthermore, if the user sets the handheld communication device in a silent mode and simultaneously activates its vibrator function, the user could still get disturbed by the vibrator in response to an incoming telephone call. This is because most users tend to look at the display of the device to see who is calling.

If the user does not want to be unnecessarily disturbed by incoming calls the user may consider turning off the handheld communication device and activate an answering machine function of the handheld communication device. In the known prior art, this answering machine function is normally offered by the service operators as a network based answering machine service. When the answering machine function is activated, incoming calls cannot be answered by the user of the handheld communication device. Instead, incoming calls are answered by the answering machine function, which thereby outputs a voice message as it is being pre-recorded by the user. When the answering unit is activated, there is a consequently a risk that important telephone calls or emergency calls are missed by the user. Missing an important telephone call or an emergency call may sometimes be disadvantageous or even disastrous for the user.

A possible solution to the problem of reducing the risk of missing important telephone calls or emergency calls could be to never turn off the handheld communication device and, thus, always being available for incoming calls. However, this is not a very convenient solution since it would mean that the user could potentially be unnecessarily disturbed by incoming calls, e.g. when attending a meeting, when on a vacation, etc.

Hence, an improved answering unit and/or method for handling incoming calls would be advantageous. In particular, an improved answering unit and/or method allowing for limiting the risk of missing important telephone calls and at the same time limiting the risk of being unnecessarily disturbed by incoming telephone calls would be advantageous.

### SUMMARY OF THE INVENTION

Accordingly, some embodiments of the present invention preferably seek to mitigate, alleviate or eliminate one or more of the above-identified deficiencies in the art and disadvantages singly or in any combination.

An aspect of the present invention relates to a method of handling an incoming call from a first communication device addressed to a second communication device, the first and second communication devices being operative in a communication network, wherein the second communication device or the communication network comprises an answering unit, the answering unit including a privacy data unit comprising a privacy code message for bypassing the answering unit, the method comprising:

receiving the incoming call by the answering unit;

determining whether also a code message is received by the answering unit; and if so

comparing the received code message with the privacy code message stored in the privacy data unit to determine whether the incoming call should bypass the answering unit and, thereby, be directly forwarded to the second communication device being addressed by the first communication device in the incoming call.

In one embodiment, the method further comprises, prior to the determining step:

transmitting a request to the first communication device for requesting a user of the first communication device to enter the code message at the first communication device and to return said entered code message.

In one embodiment, the method comprises:

outputting a pre-recorded voice message, wherein said pre-recorded voice message includes said request as part of the pre-recorded voice message.

In one embodiment, the method comprises:

automatically outputting said pre-recorded message when the answering unit receives the call.

In one embodiment, the code message is a code message from the group comprising: a numerical code message, an alphabetic code message or a combined numerical and alphabetic code message.

In one embodiment, the code message is telephone number.

In one embodiment, the code message is a sound message which is recognizable by the answering unit through speech recognition.

The features of the above-mentioned embodiments can be combined in any combinations.

Another aspect of the present invention relates to a computer program product embodied on a computer readable medium, the computer program product comprising computer program code means to execute the above-mentioned method when said computer program code means is run by an electronic device having computer capabilities.

Another aspect of the present invention relates to an answering unit for handling an incoming call from a first communication device addressed to a second communication device, the first and second communication devices being operative in a communication network, wherein the answering unit is configured to receive and answer said incoming call and wherein the answering unit further comprises:

a privacy data unit comprising a privacy code message for bypassing the answering unit; and

a controller configured to determine whether a code message is received by the answering unit, and if so the controller is further configured to compare the received code message with the privacy code message stored in the privacy data unit to determine whether the incoming call should bypass the answering unit and, thereby, be directly forwarded to the second communication device being addressed by the first communication device in the incoming call.

In one embodiment, the controller is configured to transmit a request to the first communication device for requesting a user of the first communication device to enter the code message at the first communication device and to return said code message.

In one embodiment, the controller is configured to output a voice message, wherein said pre-recorded voice message includes said request as part of the pre-recorded voice message.

In one embodiment, said pre-recorded voice message is automatically output by said controller when the answering unit receives the call.

In one embodiment, the answering device is located in the addressed second communication device.

In one embodiment, the second communication device is a portable radio communication equipment, a mobile radio terminal, a mobile telephone, a cellular telephone, a communicator, an electronic organizer, a personal digital assistant (PDA), a handheld computer, a handheld VoIP telephone, a smartphone.

In one embodiment, the answering device is located in a network node of the communication network.

In one embodiment, the network node is a base station controller.

In one embodiment, the network node is a mobile switching center.

In one embodiment, the code message is a code message from the group comprising: a numerical code message, an alphabetic code message or a combined numerical and alphabetic code message.

In one embodiment, the code message is telephone number.

In one embodiment, the code message is a sound message which is recognizable by the answering unit through speech recognition.

The features of the above-mentioned embodiments can be combined in any combinations.

Some embodiments of the invention provide for an improved answering unit and method for handling incoming calls to a communication device. As compared with the known prior art, it is an advantage with some embodiments of the invention that certain prioritized incoming calls may bypass or pass through the answering unit despite the fact that the answering unit is indeed in its active state. Thus, some embodiments of the present invention may provide the user of a communication device with a more limited risk of missing important telephone calls and at the same time a more limited risk of being unnecessarily disturbed by incoming telephone calls. Accordingly, some embodiments of the invention may allow for the implementation of improved answering machine functionality.

### BRIEF DESCRIPTION OF THE DRAWINGS

Further objects, features and advantages of the invention will appear from the following detailed description of embodiments of the invention, wherein embodiments of the invention will be described in more detail with reference to the accompanying drawings, in which:

FIG. 1 is a schematic view of a handheld communication device connected to a communication network;

FIG. 2 is as schematic block diagram of an embodiment of an answering unit for handling an incoming telephone call;

FIG. 3 is as schematic block diagram of an embodiment of a handheld communication device connected to a network node;

FIG. 4 is as schematic block diagram of another embodiment of a handheld communication device connected to a network node;

FIG. 5 is as schematic block diagram of another embodiment of a handheld communication device connected to a network node; and

FIG. 6 is a flow chart of a method for call handling according to an embodiment of the invention.

### DETAILED DESCRIPTION OF EMBODIMENTS

Embodiments of the present invention will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

Aspects of the invention may be implemented in methods and/or computer program products. Accordingly, the invention may be embodied in hardware and/or in software (including firmware, resident software, microcode, etc.). Furthermore, the invention may take the form of a computer program product on a computer-usable or computer-readable storage medium having computer-usable or computer-readable program code embodied in the medium for use by or in connection with an instruction execution system. The actual software code or specialized control hardware used to implement aspects consistent with principles of the invention is not limiting of the invention. Thus, the operation and behavior of the aspects were described without reference to the specific software code, it being understood that one of ordinary skill in the art would be able to design software and control hardware to implement the aspects based on the description herein. Further, certain portions of the invention may be implemented as “logic” that performs one or more functions. This logic may include hardware, such as an application specific integrated circuit or field programmable gate array, software, or a combination of hardware and software.

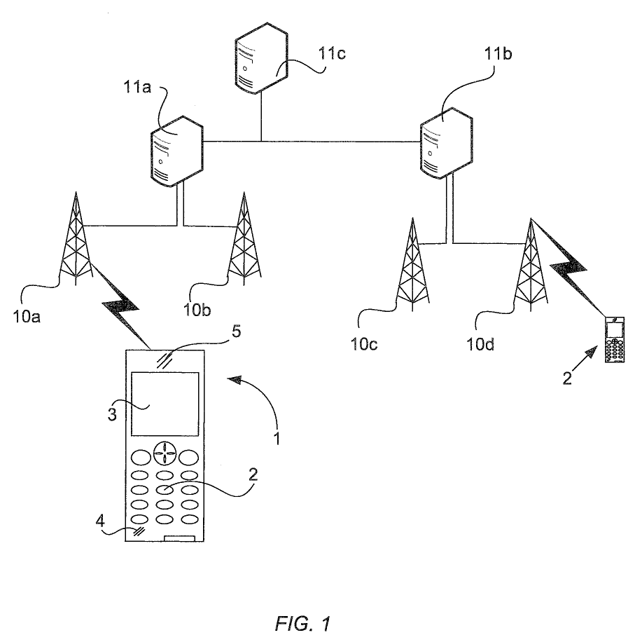

Furthermore, different embodiments and aspects of the invention will be described with reference to two communication devices, wherein one of the communication devices places a telephone call intended for and addressed to the other communication device. FIG. 1 illustrates a communication device 1 operative in a communication network. The communication device 1 may communicate wirelessly with network nodes 11 of the communication network. Furthermore, the communication device 1 may communicate wirelessly with communication device 2 via the communication network. The communication network may comprise one or several base stations 10a, 10b, 10c, 10d. Each base station 10a, 10b, 10c, 10d may be connected to a base station controller 11a, 11b, which controls signal traffic relayed to/from the communication device 1 via the base stations 10a, 10b, 10c, 10d. Moreover, each base station controller 11a, 11b may control and monitor one or several base stations 10a, 10b, 10c, 10d. Further, each base station controller 11a, 11b may be connected to one or more mobile switching centers 11c, which may be the interface between the communication network and another network, such as e.g. a public switched telecommunication network (PSTN) and/or an information network, such as the Internet.

In FIG. 1, the communication device 1 is exemplified as a handheld communication device and more specifically as a mobile telephone. At the date of filing of this specification, a mobile telephone is the best known mode of operation of some embodiments of the present invention. The mobile telephone 1 includes a user interface comprising an input device, preferably including a set of keys 2, and additionally or optionally a touch-sensitive display. An output device of the user interface includes a display 3 for presenting information to a user of the mobile telephone 1. For the purpose of conducting speech communication, mobile telephone 1 further preferably includes a microphone 4, a speaker 5 and an antenna (not shown). The actual function of mobile telephone 1 as a radio communications device is known to persons skilled in the art, and will therefore not be described in further detail herein. Although the communication device 1 is exemplified as a mobile telephone in FIG. 1, it should be appreciated that the handheld communication device 1 may, in other embodiments, be any other communication device such as a portable radio communication equipment, a mobile radio terminal, a cellular telephone, a communicator, an electronic organizer, a personal digital assistant (PDA), a handheld computer, a handheld VoIP (Voice over IP (Internet Protocol) ) telephone or a smartphone. Furthermore, the outer appearance of the mobile telephone illustrated in FIG. 1 need not take the indicated shape of FIG. 1, instead the mobile phone may e.g. be of a clamshell type, a jack knife type, or the like. Moreover, in FIG. 1 the communication network comprises base stations. However, the communication network need not necessarily be a wireless communication network. In another embodiment, it could be a wire line based network, such as a packet switched network, e.g. the Internet, comprising network nodes. Such a network may e.g. be suitable for VoIP telephony.

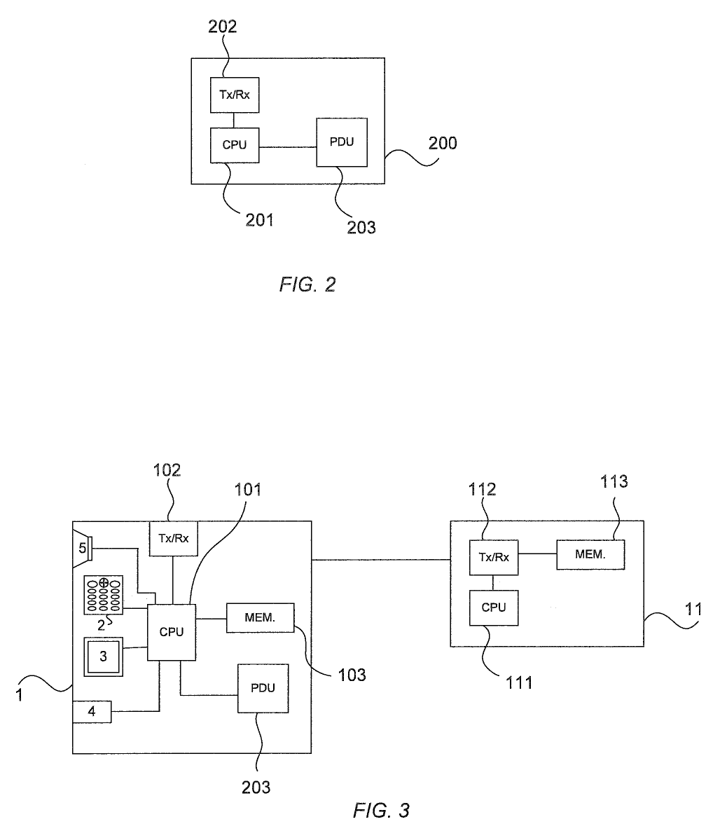

FIG. 2 schematically illustrates functional features of an answering unit 200 according to one embodiment of the invention, which answering unit 200 may allow for an improved concept for handling a telephone call. The structure and design of the answering unit 200 is schematically shown by means of a block diagram. It should be noted that the elements indicated in FIG. 2 need not necessarily be physically divided in the manner shown, and that it is the functional relationship rather than the structural arrangement that is of primary interest. The answering unit 200 comprises a controller 201 such as a CPU (Central Processing Unit), a transmitter/receiver (Tx/Rx) unit 202 for transmitting radio signals to/from the answering unit 200, and a privacy data unit (PDU) 203. When the answering unit is activated, the answering unit 200 is configured to receive and answer an incoming telephone call from communication device 2 intended for and addressed to communication device 1 (see FIG. 1). The privacy data unit 203 comprises at least one privacy code message for bypassing the answering unit 203.The controller 201 may be configured to transmit a request to the calling communication device 2 for requesting a user of this communication device 2 to enter a code message at this communication device 2 and to return the code message to the answering unit. If the returned code message is received by the answering unit, the controller 201 is further configured to compare the received code message with the privacy code message stored in the privacy data unit 203 to determine whether the call should bypass the answering unit 201 and, thereby, be directly forwarded to the communication device 1 being addressed by the calling communication device 2 in the incoming call. Thereby, the incoming call may bypass or pass through the answering unit 200 and the user of the addressed communication device 1 becomes permitted to intercept the call and can, hence, answer the call from the calling communication device 2 directly. The answering unit may be implemented within a communication device, such as the mobile telephone 1 illustrated in FIG. 1. Alternatively, or additionally, the answering unit may be implemented within the communication network, e.g. within a network node 11, such as either or both of the base station controller 11a, 11b and the mobile switching centre 11c.

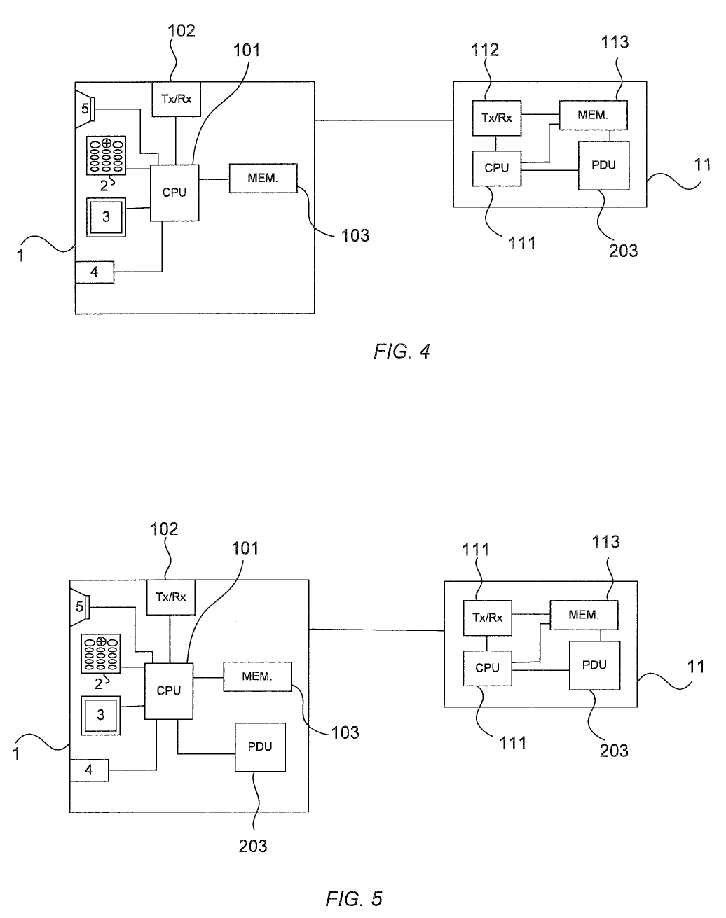

FIG. 3 schematically illustrates functional features of one embodiment of a communication device 1 implementing an answering unit. The structure and design of the handheld communication device 1 is schematically shown by means of a block diagram. It should, however, be noted that the elements indicated in FIG. 2 need not necessarily be physically divided in the manner shown, and that it is the functional relationship rather than the structural arrangement that is of primary interest. It should also be noted that the list of features and elements included in the handheld communication device 1 is in no way exhaustive. On the contrary, while the communication device 1 shown and described represents only one possible embodiment, it may well comprise further features and elements providing other functions. As can be seen in FIG. 3, the communication device 1 comprises, apart from the elements already outlined above with reference to FIG. 1, a controller 101 such as a CPU (Central Processing Unit), a transmitter/receiver (Tx/Rx) unit 102, a memory 103 and the privacy data unit (PDU) 203. The communication device 1 may be connected to a network node 11 comprising a controller 111, such as a CPU, a Tx/Rx unit 112, and a memory 113. Messages received in the network node 11 may be forwarded immediately. Alternatively, the message may be temporarily stored in the network node 11, whereupon a notification is issued and the message is forwarded on request. FIG. 4 illustrates another embodiment of a communication device 1 comprising a controller 101, a Tx/Rx unit 102, and a memory 103. The communication device 1 may be connected to a network node 11 comprising a controller 111, a Tx/Rx unit 112, a memory 113, and the PDU 203. FIG. 5 illustrates an embodiment being a combination of the embodiments of FIGS. 3 and 4, wherein both the handheld communication device 1 and the network node 11 comprise the PDU 203.

The memories 103, 113 may comprise a non-volatile memory, a volatile memory, a flash memory, a RAM (Random Access Memory), and/or ROM (Read Only Memory). The different memories are jointly denoted by each of the reference signs 103, 113. The Tx/Rx units 102, 112 may be configured to communicate wirelessly, such as according to any radio technology such as those specified according to the GSM (Global System for Mobile communication), the PDC (Personal Digital Cellular), the 3GPP (3d Generation Partnership Project) or the CDMA2000 (Code Division Multiple Access) specifications. Additionally, the Tx/Rx units 102, 112 may be configured to communicate wirelessly in accordance with a short-range communication standard, such as Bluetooth®, WLAN, WiFi or any IEEE 802.11.x standard. The communication device 1 may also be a cordless or wire connected telephone unit, wherein the Tx/Rx unit 102 may be adapted for packet switched communication. The controllers 101, 111 are depicted in the figures as a central element, responsible for carrying out different tasks of the handheld communication device 1 and the network node 11, respectively, such as controlling communication sessions. Furthermore, in order to implement the answering machine function according to various embodiments of the present invention the controllers 101, 111 are responsible for carrying out at least the same tasks as the controller 201 described earlier.

The communication device 1 may configured to receive a message, which is relayed by the base station 10a, 10b, 10c, 10d. The message may be a text message such an SMS (Short Message Service) message, an image, a video or an audio message such as a voice message.

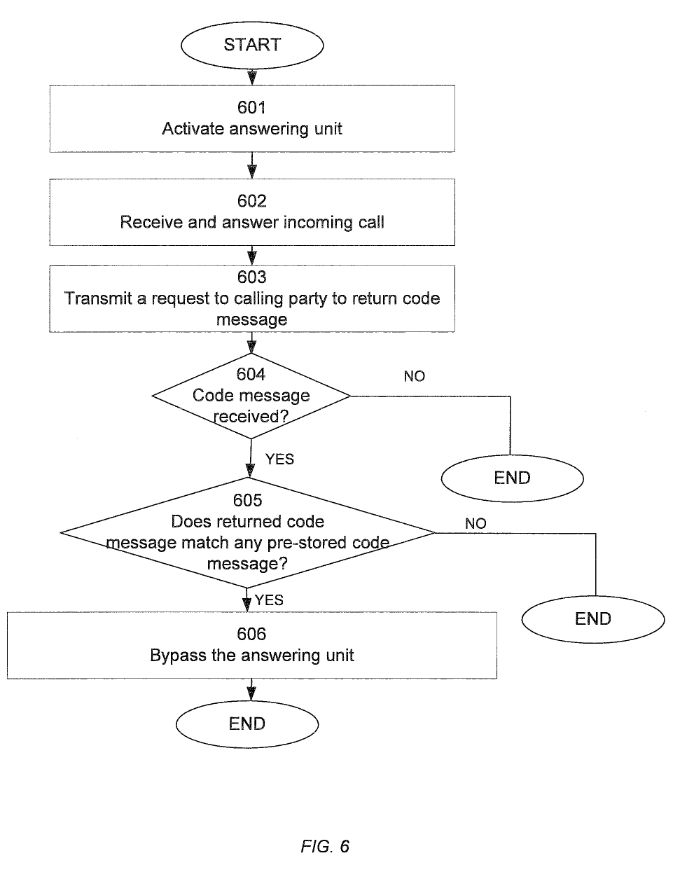

An exemplary embodiment of the overall method for realizing and using embodiments of the invention will now be described with reference to FIG. 6. The overall inventive idea could be said to be to implement an answering machine functionality, which can be bypassed or passed through by certain telephone calls which are determined to be invited by the communication device 1 to which the telephone call in question is intended and addressed. As described earlier, an answering unit may be integrated locally within the communication device 1 or, alternatively, within the communication network such as within a network node 11. However, it should be appreciated that it may be advantageous to locally implement the answering unit in the communication device 1. This is inter alia because a locally implemented answering unit within the communication device 1 may be more easily configurable by the user of the communication device 1.

Initially, the user of communication device 1 has told or announced a certain code message to certain persons that might place important calls or emergency calls to the communication device 1. The code message may be any kind of code message. As a mere example, the code message may take the form of a numerical code message, an alphabetic code message or a combination thereof. Alternatively, the code message could be a certain telephone number. If the code message is a telephone number, this telephone number may in some embodiments be derived automatically from the Caller-ID functionality by means of the answering unit when a telephone call is received by the answering unit. Yet further, the code message could be a sound message, e.g. a word or sentence, which is recognizable and interpretable by the answering unit through speech recognition.

In step 601, the user of communication device 1 activates the answering unit by operating and interacting with the user interface of the communication device 1. The reason why the answering unit is activated may e.g. be that the user of the communication device 1 does not want to be unnecessarily disturbed by incoming telephone calls. This may e.g. be the case when the user is to attend a business meeting. During step 601, the user may also choose any of a number of pre-recorded voice messages to be played by the answering unit when the answering unit receives an incoming call. For example, if the user is to attend a business meeting the user may choose a pre-recorded “meeting message”, which may contain a voice message where the user says “Unfortunately, I can't answer your call at the moment because I'm in a meeting. If your call concerns an urgent matter or if your call is really important, please type the secret code message”. When the answering unit is activated, any incoming call will as a default rule be automatically answered by the answering unit. Consequently, any incoming calls will as a general rule not be answered by the user of the communication device 1. Instead, incoming calls are automatically answered by the answering unit, which thereby outputs a voice message as it is being pre-recorded by the user, e.g. the ““meeting-message” described above.

When a user of communication device 2 places a telephone call intended for and addressed to the communication device 1 (see FIG. 1), the answering unit may receive and answer the telephone call in step 602. In other words, the answering unit outputs at a voice message as it is being pre-recorded by the user, e.g. the ““meeting-message” as described above. In step 603, a request may be transmitted to the calling communication device 2 for requesting a user of this communication device 2 to enter or type in a code message at this communication device 2 and also to return the entered code message to the answering unit. In one embodiment, the request may simply be in the form of the pre-recorded voice message where the user has pre-recorded the audio message “ . . . if your call concerns an urgent matter or if your call is really important, please type in the secret code message”, as described earlier.

If the calling party who places the call to the communication device 1 does not know the requested secret code message, he/she could either choose to leave a message or not to the answering unit. If the calling party does not leave a message in the answering unit, the user of the communication device 1 may, optionally, still see that this calling party has tried to reach the user of communication device 1 in a “missed calls” list or the like.

If the calling party really has an important call and knows the secret code message, the calling party may enter or type in the code message by operating and interacting with the user interface of the calling communication device 2. Further, the entered code message may be forwarded to the answering unit.

In the subsequent step 604, it is determined whether any code message has been received by the answering unit. If the answer in step 604 is no, the method may end. If the answer in step 604 is yes, the method proceeds to step 605 in which a comparison is preformed between the received code message and the privacy code message stored in a privacy data unit of the answering unit. The privacy data unit includes at least one pre-stored or selected privacy code message for bypassing the answering unit. The privacy code messages can be said to represent calls from persons that might place important calls or emergency calls to your communication device. During the comparison in step 605 it may be determined whether the received code message matches any pre-stored privacy code message. Thus, it is possible to determine whether the call should be bypassed and, hence, directly forwarded to the communication device 1 being addressed by the calling communication device 2 in the telephone call.

Accordingly, in step 605 it may be determined whether the received code message matches any locally stored privacy code message. If the answer in step 605 is no, i.e. the received code message does not match any locally stored privacy code message, the method may end. However, if the received code message is a correct code message, i.e. the answer in step 605 is yes, the method proceeds to a step 606 where the incoming call bypasses or passes through the answering unit. So, when it is determined in step 605 that the received code message matches a locally stored privacy code message it is further determined that the incoming call should be directly forwarded to the addressed communication device 1, because the incoming call is regarded as an important call or an emergency call. In step 606, the incoming call may bypass or pass through the answering device such that the user may intercept the incoming call from the calling communication device 2. Thus, the incoming call may be answered by the user of the addressed communication device 1 despite the fact that the answering device is indeed activated.

All steps carried out in the method according to FIG. 6 need not be carried out in all embodiments. For example, the step 603 of transmitting the request to the calling party to return the code message could be dispensed with in some embodiments. Thus, in some embodiments, a request does not necessarily have to be transmitted (neither electronically nor as a request as part of the pre-recorded voice message “meeting message”) to the calling communication device 2 for requesting a user of this communication device 2 to enter and return a code message. Instead, the answering unit could simply wait for a certain time period and then determine whether any secret code message has been received by the answering unit from the calling party, i.e. communication device 2. If no code message has been received, the incoming call will simply not bypass the answering unit either.

The method according to FIG. 6 may be implemented by a computer program product comprising program code means for carrying out the method. The computer program product may e.g. be run by any of the controllers 101, 111, 201, depending on the implementation.

It has turned out that some embodiments of the invention provide for an improved answering unit and method for handling incoming calls to a communication device. It is an advantage with some embodiments of the invention that the answering unit may act as a filter for incoming calls, where certain prioritized incoming calls may bypass or pass through the answering unit despite the fact that the answering device is indeed in its active state. Thus, as compared with the known prior art some embodiments of the present invention provide for an improved answering unit and/or method, which provides the user with a more limited risk of missing important telephone calls and at the same time a more limited the risk of being unnecessarily disturbed by incoming telephone calls.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms used herein should be interpreted as having a meaning that is consistent with their meaning in the context of this specification and the relevant art and will not be interpreted in an idealized or overly formal sense unless expressly so defined herein.

The foregoing description of implementations consistent with principles of the present invention provides illustration and description, but is not intended to be exhaustive or to limit the invention to the precise form disclosed. Thus, the invention should not be construed as being limited to the particular embodiments discussed above. Rather, the above-described embodiments should be regarded as illustrative rather than restrictive, and it should be appreciated that variations may be made in those embodiments by persons skilled in the art without departing from the scope of the present invention as defined by the appended claims.

1. A method of handling an incoming call from a first communication device addressed to a second communication device, the first and second communication devices being operative in a communication network, wherein the second communication device or the communication network comprises an answering unit, the answering unit including a privacy data unit comprising a privacy code message for bypassing the answering unit, the method comprising:
receiving the incoming call by the answering unit;
determining whether also a code message is received by the answering unit; and if so
comparing the received code message with the privacy code message stored in the privacy data unit to determine whether the incoming call should bypass the answering unit and, thereby, be directly forwarded to the second communication device being addressed by the first communication device in the incoming call.

2. The method of claim 1, wherein the method further comprises, prior to the determining step:
transmitting a request to the first communication device for requesting a user of the first communication device to enter the code message at the first communication device and to return said entered code message.

3. The method of claim 2, comprising:
outputting a pre-recorded voice message, wherein said pre-recorded voice message includes said request as part of the pre-recorded voice message.

4. The method of claim 3, comprising:
automatically outputting said pre-recorded message when the answering unit receives the call.

5. The method of claim 1, wherein the code message is a code message from the group comprising: a numerical code message, an alphabetic code message or a combined numerical and alphabetic code message.

6. The method of claim 1, wherein the code message is telephone number.

7. The method of claim 1, wherein the code message is a sound message which is recognizable by the answering unit through speech recognition.

8. A computer program product embodied on a computer readable medium, the computer program product comprising computer program code means to execute the method according to claim 1 when said computer program code means is run by an electronic device having computer capabilities.

9. An answering unit for handling an incoming call from a first communication device addressed to a second communication device, the first and second communication devices being operative in a communication network, wherein the answering unit is configured to receive and answer said incoming call and wherein the answering unit further comprises:
a privacy data unit comprising a privacy code message for bypassing the answering unit; and
a controller configured to determine whether a code message is received by the answering unit, and if so the controller is further configured to compare the received code message with the privacy code message stored in the privacy data unit to determine whether the incoming call should bypass the answering unit and, thereby, be directly forwarded to the second communication device being addressed by the first communication device in the incoming call.

10. The answering unit of claim 9, wherein the controller is configured to transmit a request to the first communication device for requesting a user of the first communication device to enter the code message at the first communication device and to return said code message.

11. The answering unit of claim 10, wherein the controller is configured to output a voice message, wherein said pre-recorded voice message includes said request as part of the pre-recorded voice message.

12. The answering unit of claim 11, wherein said pre-recorded voice message is automatically output by said controller when the answering unit receives the call.

13. The answering unit of claim 9, wherein the answering unit is located in the addressed second communication device.

14. The answering unit of claim 13, wherein the second communication device is a portable radio communication equipment, a mobile radio terminal, a mobile telephone, a cellular telephone, a communicator, an electronic organizer, a personal digital assistant (PDA), a handheld computer, a handheld VoIP telephone or a smartphone.

15. The answering unit of claim 9, wherein the answering unit is located in a network node of the communication network.

16. The answering unit of claim 15, wherein the network node is a base station controller.

17. The answering unit of claim 15, wherein the network node is a mobile switching center.

18. The answering unit of claim 9, wherein the code message is a code message from the group comprising: a numerical code message, an alphabetic code message or a combined numerical and alphabetic code message.

19. The answering unit of claim 9, wherein the code message is telephone number.

20. The answering unit of claim 9, wherein the code message is a sound message which is recognizable by the answering unit through speech recognition.
